(19) United States
(12) Patent Application Publication
(10) Pub. No.: US 2006/0155680 A1
(43) Pub. Date: Jul. 13, 2006

(54) Search file indicating languages associated with scenes

(76) Inventors: Peng Wu, San Jose, CA (US); Ullas Gargi, San Jose, CA (US); Pere Obrador, Mountain View, CA (US); Philip M. Walker, Fort Collins, CO (US); Paul Boerger, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/032,330

(22) Filed: Jan. 10, 2005

(51) Int. Cl. G06F 17/00

(52) U.S. Cl. 707/3

(57) ABSTRACT

An optical disc having a search file indicating languages associated with scenes, and methods associated therewith. In some embodiments, the optical disc is configured to store content and a search file. The content is playable by an optical disc player. The search file comprises data associated with scenes in the playable content. For a given scene, the data indicates a language associated with that scene.

### RELATED APPLICATIONS

The present application relates to co-pending U.S. patent application Ser. No. ______ (Dkt# 200501208), entitled “Disc Content Enhancement Systems and Methods,” filed Jan. 10, 2005, and hereby incorporated herein by reference.

### BACKGROUND

Film producers and movie studios routinely make shows available to consumers on optical disc for home viewing. With the advent of high-capacity optical discs, it has become possible to offer additional content and features to published optical discs. One proposed feature is an enhanced search capability that would be able to identify scenes in a movie having certain actors or characters. However, proposed formats for the disc content allow for the possibility that a scene may have multiple versions, e.g., a scene could be rendered in different languages. It would be desirable to provide any enhanced search capability with the power to differentiate between multiple versions of a given scene. The differentiation should be implemented in a manner that provides maximum flexibility but ensures consistent operation on different platforms.

### BRIEF DESCRIPTION OF THE DRAWINGS

In the subsequent detailed description, reference will be made to the accompanying drawing in which:

FIG. 1 shows a block diagram of an illustrative optical disc player;

FIG. 2 shows a block diagram of an illustrative software architecture for an optical disc player;

FIG. 3 shows an illustrative file structure for an optical disc;

FIG. 4 shows a graphical representation of illustrative scene elements;

FIG. 5 shows an illustrative enhanced search interface;

FIG. 6 shows a flow diagram of an illustrative enhanced search process;

FIG. 7 shows an illustrative schema for a search file; and

FIG. 8 shows an illustrative search file.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the terms “couple” or “couples” and “connect” or “connects” are intended to mean either an indirect or direct electrical connection. Thus, if a first device couples or connects to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure or the claims. In addition, one skilled in the art will understand that the following description has broad application, and the discussion of any embodiment is meant only to be illustrative of that embodiment, and not intended to suggest that the scope of the disclosure or the claims is limited to that embodiment.

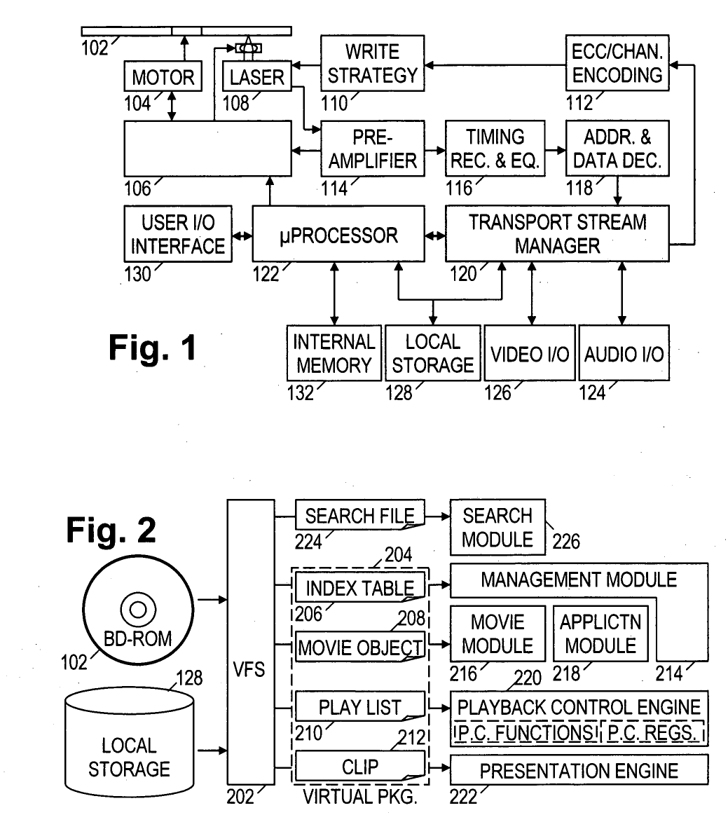

FIG. 1 shows an illustrative optical disc player. In the player, an optical disc 102 is rotated by a motor 104. The motor's rotation rate is controlled by controller 106, which also controls the read/write position of laser 108. Laser 108 reads data from optical disc 102, and if the optical disk is recordable, the laser can write data to the optical disc. Laser 108 receives encoded write data from write strategy module 110, which compensates for nonlinearities in the laser's write performance. The encoded write data is provided to write strategy module 110 by encoder module 112. Encoder module 112 encodes a write data stream using error correction code (ECC) and channel encoding strategies to respectively protect against data recovery errors and ensure compatibility with the physical storage medium.

Laser 108 detects changes in reflected light intensity to read data from optical disc 102. Laser 108 provides a read signal to pre-amplifier 114, which amplifies the signal and provides it to module 116 for timing recovery and equalization. Pre-amplifier 114 further provides a tracking error signal that controller 106 uses for feedback control of the read/write position of laser 108. Timing and equalization module 116 provides an equalized read signal to address & data decoder 118. The decoder forms one or more read data streams from the address and data information extracted from the read signal. A transport stream manager 120 operates under control of microprocessor 122 to direct, multiplex, and de-multiplex data streams to and from various components. Transport stream manager 120 receives a data stream from decoder 118, de-multiplexes the data stream into component streams, and directs the component streams as appropriate to audio block 124, video block 126, local storage 128, and microprocessor 122. Manager 120 further accepts one or more component streams from audio block 124, video block 126, local storage 128, and microprocessor 122, multiplexes the one or more component streams into a single write data stream, and directs the write data to encoder 112.

Audio block 124 is an interface for audio output and audio input. Accordingly, audio block 124 may be configured to connect to speakers and headphones, and may be further configured to receive a line input or audio input from another source. (The audio block 124 is optional and may be omitted in some embodiments.)

Video block 126 is an interface for video output and video input. Accordingly, video block 126 may be configured to connect to a television monitor, or video screen, and may be further configured to receive video input from an external source.

Local storage 128 is a persistent information storage device, and may take the form of a disk drive, solid state device, or other large capacity storage device. Local storage 128 may be used to build an information library regarding optical discs that have been played, and may further be used to store content from one or more of the optical discs for later playback without the disc.

Microprocessor 122 coordinates the operation of the various player components in response to input from user interface 130. The user interface 130 may comprise various lights, buzzers, and digital displays for providing status information and feedback to the user. The microprocessor's operation is determined by software stored in internal memory 132. Internal memory 132 serves also as a data cache for the microprocessor's operations.

The software executed by microprocessor 122 may be represented with a software architecture diagram. FIG. 2 shows an illustrative software architecture diagram having blocks for a virtual file system (VFS) module 202, a management module 214, a movie module 216, an application module 218, a playback control engine 220, a presentation engine 222, and a search module 226. When an optical disc 102 is inserted in the disc player, the VFS module 202 creates a virtual package 204.

Virtual package 204 is constructed from disc content combined with stored information from local storage 128 (or in the absence of local storage 128, stored information from internal memory 132). The virtual package 204 represents the contents of a virtual disc. The use of a virtual package 204 allows for modification of an optical disc's operation with no modification to the optical disc itself. In the absence of stored information, the virtual package 204 will be identical to the contents of optical disc 102.

Virtual package 204 comprises an index table 206, one or more movie objects 208, one or more play lists 210, and one or more clips 212. The index table 206 is a table that defines a top-level menu and identifies the titles on the disc. The menu and titles are identified in terms of the movie object(s) that implement the menu or launch playback of the title. The index table further specifies a movie object or application to be automatically played when a disc is inserted into the player.

A movie object 208 is a navigation program that initiates playback of a play list and/or interacts with a user to select a play list or another movie object. A play list 210 is an ordered collection of playing intervals in the clips. The playing intervals are specified in terms of a start point and an end point in a given clip. A clip 212 is an audio-visual stream file (“clip stream file”) together with associated database attributes (“clip information file”). The clip stream file may be, for example, an MPEG-2 transport stream as provided in ISO/IEC 13818-1, and it may comprise multiplexed video, audio, graphics, and text streams. The clip information file identifies time-stamped access points to the clip stream file.

Management module 214 controls the top-level operations of the player, including determining which movie objects are to be executed and initiating execution of those movie objects associated with menus and titles. Movie module 216 is called by management module 214 to execute a given movie object. Movie module 216 calls playback control engine 220 with the play lists to be displayed. Playback control engine 220 also responds to commands by management module 214 for “trick play” modes such as fast-forward, pause, rewind, restart, and jump-to-next-scene. These modes are initiated via the playback control functions and playback control registers embedded within the playback control engine 220. Playback control engine 220 causes presentation engine 222 to retrieve clips 212 and play the clip content to the user via video screens and speakers.

Application module 218 is provided for executing software content from the disc. This module will not be discussed further here.

Search module 226 may be called by management module 214 in response to a user command. Search module 226 retrieves a search file 224 via VFS module 202 from disc 102, local storage 128, or internal memory 132. Search module 226 transforms the search file into selection lists for display to the user, and allows the management module 214 to associate scenes with selections from the lists.

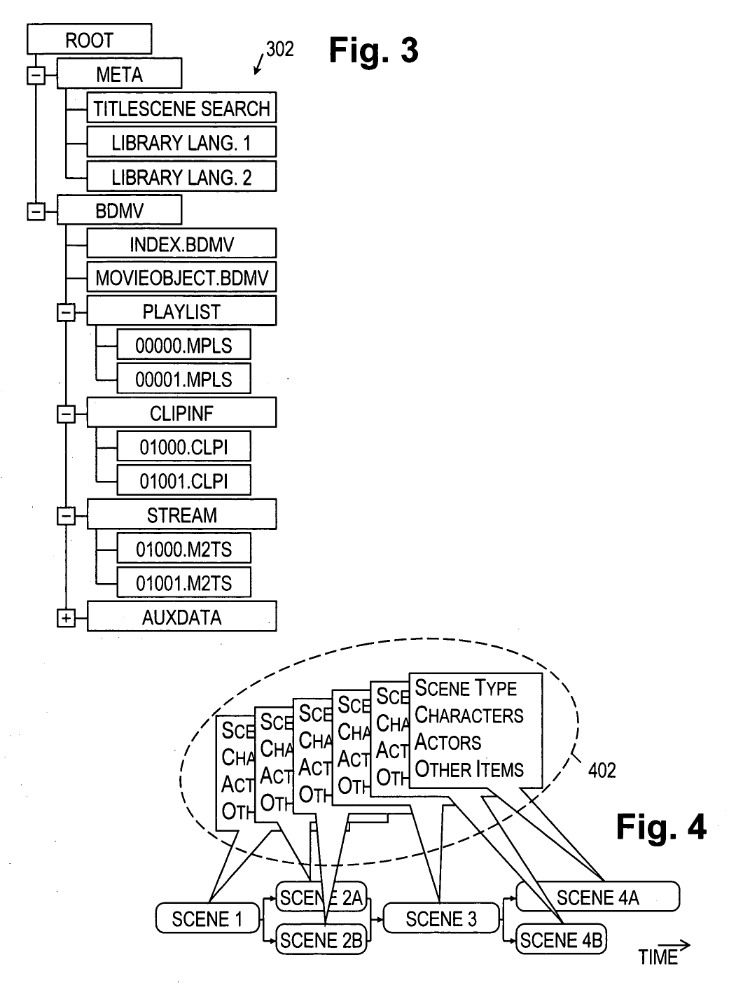

FIG. 3 shows an illustrative optical disc's file structure 302. File structure 302 begins with a top-level root directory that contains two subdirectories, Meta (short for metadata) and BDMV (short for Blu-Ray Disc Movie). The illustrative meta directory contains a TitleScene Search file and two Library files. The TitleScene Search file provides descriptive information for each scene on the disc to enable versatile content searches. The Library files are language-specific, and each library file comprises catalog information for the disc. The library files provide such information as the disc title, a description of the disc, a table of contents for the disc, whether the disc is part of a set, copyright license rights, release date, creator, publisher, format, genre, audio track language, ratings, and sources for additional information.

The BDMV directory comprises an index file, a movie object file, and four subdirectories: Play List, ClipInf, Stream, and AuxData. The index file is the source of the index table 206 described previously. The movie object file is the source of the movie objects 208 described previously. The Play List directory comprises a file for each play list, the files being named with a five-digit play list identifier. The ClipInf directory comprises the clip information files described previously, and the Stream directory comprises the clip stream files described previously. (There is a one-to-one correspondence between the clip information files and the clip stream files.) The AuxData directory contains sound files and font files for graphics screens (such as menus).

FIG. 4 shows an illustrative sequence of scenes that may be part of a larger movie. The sequence comprises two sets of parallel paths. There are two paths that may be followed at the end of scene 1. A first path plays scene 2A, while the second path plays scene 2B. The paths rejoin at the beginning of scene 3. A second set of parallel paths follows scene 3, where either scene 4A or scene 4B may be played. Each set of parallel paths may comprise more than two paths, and may extend over multiple scenes.

Parallel paths may be used to provide language-specific scenes. For example, the title credits for a movie may be provided in different languages. As another example, a newspaper that appears in a scene may be in English in one version, and Japanese in another version. The disc player may automatically select a path based on a configuration set up by the user, or the user could select a desired path when initiating playback of the movie.

FIG. 4 also shows a graphical representation of scene elements 402 that are provided in the search file. Scene elements 402 are data structures associated with the scenes in a title. The scene elements 402 may identify (among other things) the type of scene, the characters present in the scene, and the actors present in the scene. Each scene, even the scenes in parallel paths, is associated with a corresponding scene element.

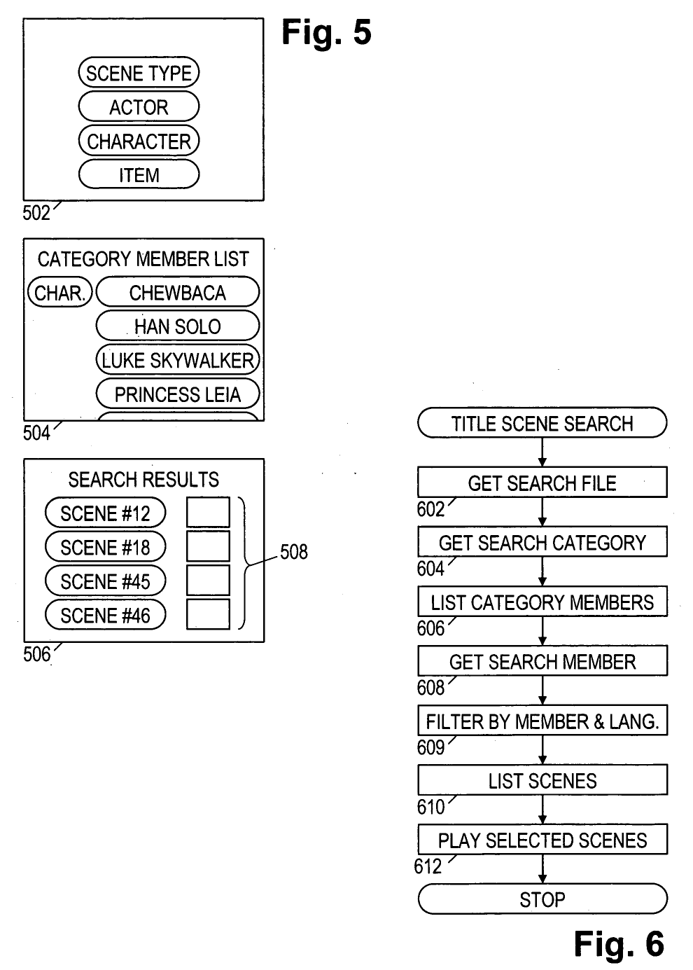

FIG. 5 shows an illustrative series of screens that may be used by a player to implement an enhanced search feature. In response to a user's pressing a remote control button, the player may display a list of categories such as that shown in screen 502. When the user selects a category, the player may comb through the search file to find all members of that category and may then display a list of those members as shown in screen 504. If the list is too long to fit on a screen, the player may allow the user to scroll through the list. When the user selects a member of that category, the player displays a list of all scenes having that category member. A thumbnail image 508 from each scene may also be displayed as shown in screen 506. When the user selects a scene, the player may begin showing that scene.

FIG. 6 shows a flow diagram of an illustrative title scene search process. In block 602, the player retrieves the search file. In block 604, the player displays a list of categories on the screen and receives a category selection from the user. In block 606, the player determines a list of members in the selected category. In block 608, the player displays the list on the screen and receives a member selection from the user.

In block 609, the player determines a list of scenes in the movie that have the selected category member. The list may be filtered by language preference to avoid listing different language versions of the same scene. Alternatively, the list may comprise different language versions of a given scene and may specify the associated language. In block 610, the player displays the scene list on the screen and receives a scene selection from the user. In block 612, the player initiates playback of the selected scene.

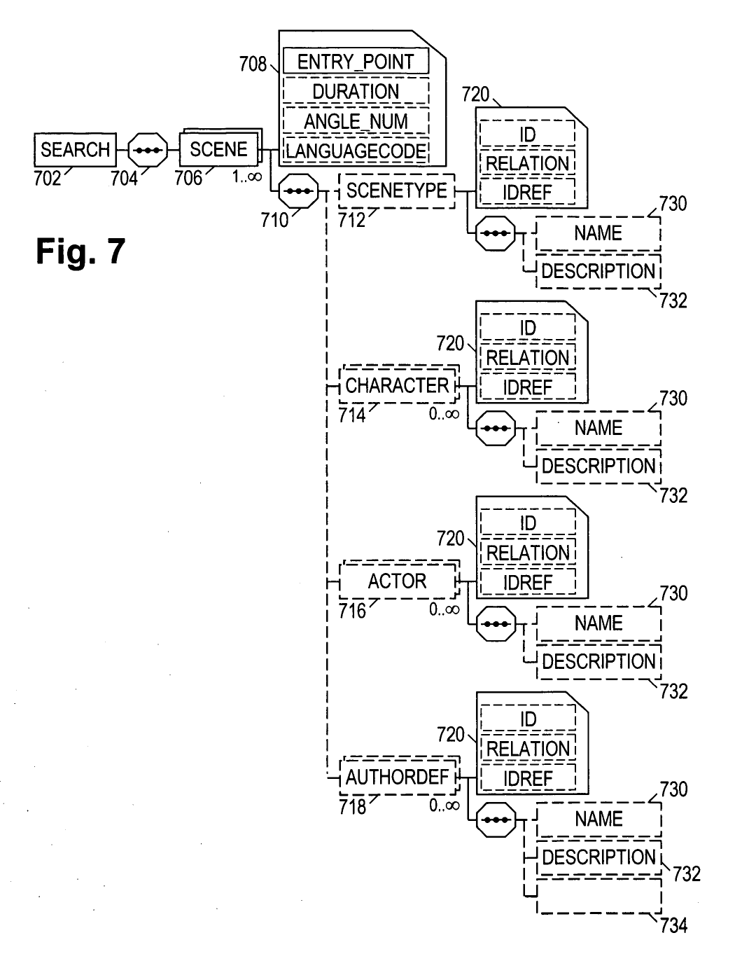

FIG. 7 shows an illustrative schema for the search file. The search file may be structured using the extended markup language (XML). An XML file comprises elements that are delimited by tags. The tags identify the elements, and may further comprise attribute values associated with the elements. An element's content appears between its delimiters, and nested structures are permitted. White space, i.e., tabs, spaces, and line breaks, are largely ignored except as may be needed within a tag to separate an element's name from any attribute values that may be specified.

The search file schema begins with a top-level search element 702. The search element has no attributes, but it does have sub-elements as indicated by nesting symbol 704; The sub-elements to search element 702 are scene elements 706. Search element 702 comprises at least one scene element 706, and may comprise more than one.

Each scene element 706 has one or more attributes 708, and may have sub-elements as indicated by nesting symbol 710. Each scene element 706 comprises an entry_point attribute that specifies the starting point for the scene. The starting point is specified in terms of elapsed time from the beginning of the movie. Each scene element 706 may comprise a duration attribute, an angle_num attribute, and/or a languagecode attribute. The duration attribute specifies the time length of the scene. The angle_num specifies the a camera angle associated with the scene when the scene is one in which multiple camera angles have been provided. The languagecode attribute identifies the language associated with a scene, and it is intended for use with scenes where multiple language versions have been provided.

The languagecode attribute may be assigned a three-character string value to identify the language associated with the scene. Suitable attribute values are the standard three-letter codes have been established in ISO 639-2:1988 “Codes for the representation of names of languages—Part 2: Alpha-3 code.” However, other attribute values could also be used to represent languages.

The optional sub-elements of the scene element 706 are the scenetype element 712, the character element 714, the actor element 716, and the authordef element 718. Each of these elements may have attributes 720 and sub-elements 730, 732. The scenetype element 712 is intended to provide a description of the scene. The scene element may comprise multiple character elements 714, each of which is intended to identify a character in the scene. Similarly, multiple actor elements 716 may be provided, each of which serves to identify an actor or actress present in the scene. Finally, there may be multiple authordef elements 718, each of which may be defined by the author to provide information about other aspects of the scene.

The name sub-element 730 for each of the scenetype element 712, the character element 714, the actor element 716, and the authordef element 718, serves to provide a value for that element. Thus, the name sub-element 730 for the scenetype may contain a brief description of the scene, whereas the name sub-element for the actor may contain the name of the actor. The description sub-element 732 serves to provide additional description about the element in question.

The authordef element 718 may further comprise an authordef sub-element 734, where the author can provide additional information with a customized structure. The authordef sub-element 734 may comprise additional, nested levels of information.

Optional attributes 720 comprise the id attribute, the relation attribute, and the idref attribute. The id attribute is a unique identifier for the element, i.e., the id attribute is assigned a value that is not shared with any other element in the search file. The relation attribute is a uniform resource identifier (URI) that identifies where additional information related to the element can be found. For example, the relation attribute for an actor element could specify an internet site having a biography for the actor. Finally, the idref attribute is a reference to a preceding element in the search file where attributes and sub-elements for the current element can be found. The idref allows repetitious information to be omitted from the search file. For example, once an element has been defined for an actor in one scene, all the subsequent scenes having that actor can simply have an empty actor element that refers back to the previously defined actor element.

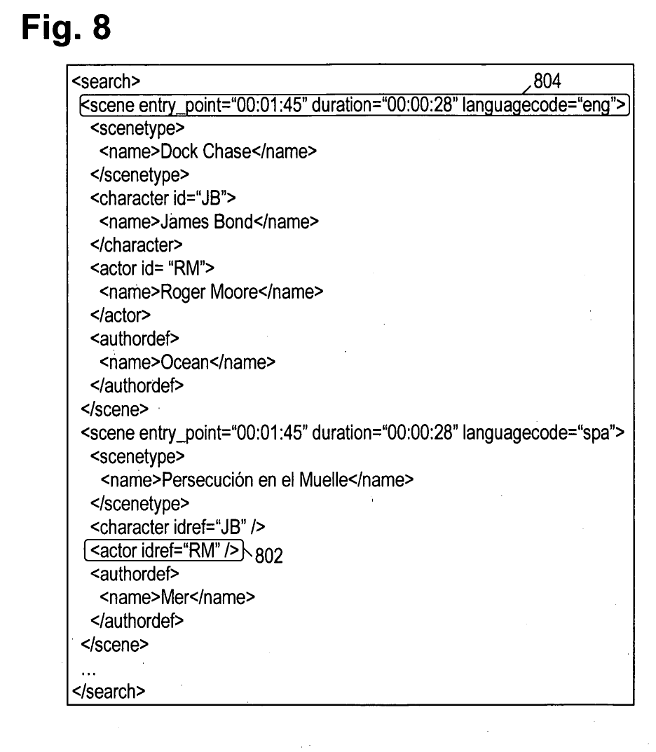

An illustrative search file is shown in FIG. 8. Note that the tags are identified with angle brackets < >, and the tags generally provided in pairs, e.g., the <search> tag and the </search> tag delimit the contents of the search element. The exception to this rule occurs for empty elements such as the actor element 802. An empty element is an element with nothing between the delimiters, e.g., <actor></actor>. Such a construction may be abbreviated as <actor/>.

Attributes for an element are included between the angle brackets and after the element name. Attributes are specified using an equals sign. The attribute name appears on the left side of the equals sign, and the attribute's value appears in quotes on the right side of the equals sign. For example, the actor element 802 is shown having a single attribute: idref.

The search file provides information regarding scenes in the movie. The structured information appears in the search element between the <search> and </search> delimiters. The information shown in FIG. 8 includes two scene elements that may be differentiated by their languagecode attribute values. Scene element 804 has an entry point of 1 minute, 45 seconds, a duration of 28 seconds, and its associated language is English. The following scene element has the same entry point and duration, but has Spanish as the associated language. These two scenes appear on parallel paths, but the language code attribute value allows the player to distinguish them when performing a search. The player could filter scene elements base on the language code attribute value at any stage of the search, or alternatively, the player could display each of the scenes in the search results.

The above discussion is meant to be illustrative of the principles and various embodiments of the present invention. Numerous variations and modifications will become apparent to those skilled in the art once the above disclosure is fully appreciated. For example, the foregoing description was made in the context of optical discs, but the disclosed material is equally applicable to other forms of information storage. Also, the language differentiation was made using an attribute of the scene element, but could alternatively be made using a language sub-element of the scene element. It is intended that the following claims be interpreted to embrace all such variations and modifications.

What is claimed is:

1. An optical disc configured to store information for use by an optical disc player, wherein the information comprises:
playback content that is playable by the optical disc player; and
at least one title search file that comprises data associated with scenes in the playback content, wherein the data for a given scene indicates a language associated with the given scene.

2. The optical disc of claim 1, wherein the title search file comprises structured elements expressed in an extended markup language (XML).

3. The optical disc of claim 2, wherein the title search file divides the playback content into scenes and associates a corresponding scene element with each scene.

4. The optical disc of claim 3, wherein each scene element comprises at least one attribute, and wherein at least one scene element comprises an attribute that indicates the language associated with the corresponding scene.

5. The optical disc of claim 4, wherein the attribute identifies the language using a standard code for representing language names.

6. The optical disc of claim 5, wherein the standard code is that given by ISO 639-2:1998.

7. The optical disc of claim 3, wherein at least one of the scene elements comprises a sub-element that identifies the language associated with the corresponding scene.

8. The optical disc of claim 1, wherein the playback content is Blu-Ray Disc standard-compliant.

9. An indexing method that comprises:
creating a title search file, wherein the title search file comprises a chronological series of scene elements, wherein at least one of the scene elements identifies a language associated with a corresponding scene; and
storing the title search file on a disc with title content.

10. The method of claim 9, wherein each scene element provides information about a corresponding scene in the title content.

11. The method of claim 9, wherein the at least one scene element comprises an attribute that identifies the language associated with the corresponding scene.

12. The method of claim 9, wherein the at least one scene element comprises a sub-element that identifies the language associated with the corresponding scene.

13. The method of claim 9, wherein the title content comprises parallel playback paths that are have different languages associated with each parallel path.

14. The method of claim 13, wherein the parallel playback paths each have scenes with corresponding scene elements, and wherein each of the corresponding scene elements identifies the language associated with the parallel playback path that contains the scene.

15. A searching method that comprises:
displaying a list of members in a selected category from a search file; and
determining a set of scenes that the search file associates with a selected members and a desired language.

16. The method of claim 15, wherein the search file comprises scene elements, each scene element being associated with a scene, and at least one scene element specifying a language associated with the scene.

17. The method of claim 16, wherein the at least one scene element comprises an attribute to specify the language.

18. The method of claim 16, wherein the at least one scene element comprises a sub-element to specify the language.

19. The method of claim 16, wherein the language is specified with a standard code given by ISO 639-2:1998.

20. The method of claim 15, further comprising:
playing a selected one of the set of scenes in response.
